(19) United States
(12) Patent Application Publication
(10) Pub. No.: US 2026/0236733 A1
(43) Pub. Date: Aug. 13, 2026

(54) METHOD AND DEVICE FOR DETECTING AN ANOMALY IN THE BEHAVIOUR OF A DYNAMIC SYSTEM

(71) Applicant: Hochschule Koblenz, Koblenz (DE)

(72) Inventors: Babette DELLEN, Remagen (DE); Uwe JAEKEL, Eitorf (DE)

(73) Assignee: Hochschule Koblenz, Koblenz (DE)

(21) Appl. No.: 19/160,361

(22) PCT Filed: Feb. 28, 2024
(86) PCT No.: PCT/EP2024/055143

§ 371 Date: Aug. 27, 2025

(30) Foreign Application Priority Data
Feb. 28, 2023 (DE) 10 2023 104 927.5

(51) Int. Cl. G06N 3/04; G08B 21/04

(52) U.S. Cl. CPC G06N 3/04; G08B 21/043

(57) ABSTRACT

The present disclosure relates to a method and a device for detecting an anomaly in the behaviour of a dynamic system that has state transitions between a plurality of states. In the method, at least one subset of the states is detected in a detection mode, by means of which subset an artificial neural network is trained, wherein during identification mode a future state of the system is predicted by means of the artificial neural network, the future state of the system is detected, a deviation of the detected future state from the predicted future state is determined and the anomaly is ascertained from the determined deviation.

### TECHNICAL FIELD

The present disclosure relates to a method and a device for detecting an anomaly in the behavior of a dynamic system that has state transitions between a plurality of states.

### BACKGROUND

In the field of anomaly detection, a wide range of solution approaches from time series analysis are generally known. Machine learning methods have also already been proposed for this purpose for certain applications. However, modeling, both in conventional machine learning methods and in heuristic threshold value methods, requires complex studies under controlled conditions.

In addition, the previous methods are only partially applicable to so-called wearables with weak computing power, since the models contain many parameters and can often only be evaluated numerically with great effort. In addition, conventional methods sometimes require prior knowledge of the relationships and couplings of the input parameters, which cannot be implemented with a large number of input parameters.

### SUMMARY

Against this background, the present disclosure is based on the object of providing a method and a device for detecting an anomaly in the behavior of a dynamic system (e.g. living organism, machine), which have comparably low requirements in terms of implementation, production and assembly effort. In addition, anomaly detection is intended to be able to provide reliable and accurate results without being dependent on a high computing power. The device is intended to still have a compact design.

It should be noted that the features listed individually in the claims can be combined with each other in any technically meaningful manner and show further configurations of the disclosed embodiments. The description additionally characterizes and specifies the disclosed embodiments, in particular in connection with the figures.

It should also be noted that a conjunction “and/or” used hereinbelow, which is between two features and links these together, should always be interpreted as meaning that only the first feature can be present in a first configuration of the subject matter according to the present disclosure, only the second feature can be present in a second configuration, and both the first and the second feature can be present in a third configuration.

A term “approximately” used herein indicates a tolerance range that is considered to be normal by a person skilled in the art working in the present field. In particular, the term “approximately” should be understood as meaning a tolerance range of the relevant variable of up to a maximum of +/−20%, preferably up to a maximum of +/−10%.

In a method according to the disclosed embodiments for detecting an anomaly in the behavior of a dynamic system that has state transitions between a plurality of states, at least one subset of the states is captured in a capture mode and is used to train an artificial neural network (also referred to herein only as a network for short), wherein, in a detection mode, a future state of the system is predicted by means of the artificial neural network, the future state of the system is captured using a capture means, a deviation of the captured future state from the predicted future state is ascertained, and the anomaly is determined from the ascertained deviation.

In other words, those state transitions for which no anomaly is determined represent a nominal, normal dynamic behavior of the system (also referred to herein as a normal state).

The capture means may be, for example, a sensor for capturing a mechanical vibration, an acceleration, a location in space, for capturing sound waves, electric, magnetic or electromagnetic fields and the like or any combination thereof.

The system can be, for example, a living being (e.g. human or animal) or an inanimate object such as a machine, a building, a vehicle and the like, wherein the state of the system can be captured, i.e. measured, by means of the at least one capture means.

The capture mode and/or detection mode is performed or controlled by a control unit, for example a microcontroller, a microprocessor, a digital signal processor (DSP), a single-board computer and the like, which can have a memory, such as RAM, ROM, flash, etc. The capture and detection modes can be performed by different control units, but they can be performed by the same control unit.

In any case, a signal which is provided by the capture means and describes the captured state of the system is supplied to the control unit for the purpose of performing the capture and/or detection mode. The anomaly determined in the detection mode can be recorded or stored by the control unit (e.g. for later evaluation) and/or signaled after determination, e.g. optically, acoustically and/or by means of a data transmission based on wireless or wired communication technologies that are known per se, to a remote further control unit that can start or initiate further measures corresponding to the determined anomaly.

According to one advantageous configuration of the present disclosure, the anomaly is determined by a predetermined threshold value being exceeded by the ascertained deviation.

Preferably, the artificial neural network may have at least one, preferably only one, hidden layer with hidden neurons.

According to a further preferred configuration, the hidden neurons are each in the form of multiplicative units (also referred to herein as a product unit) which are each supplied with input signals that are multiplied by each other by the respective multiplicative unit.

In comparison to conventional neural networks, the number of neurons needed of the network according to the present disclosure for the same application can be reduced by at least one order of magnitude. For example, the neural network of the method according to the present disclosure can be formed from a maximum of approximately 50 neurons, thus making it possible to significantly reduce the computational effort in the detection mode.

Preferably, in order to perform the multiplication, the input signals are logarithmized, the logarithmized input signals are added and the result of the addition is exponentiated.

The input signals are particularly preferably logarithmized using the complex logarithm function and the result of the addition is exponentiated using the complex exponential function.

Furthermore, according to one preferred configuration of the subject matter of the present disclosure, the logarithmized input signals are each multiplied by a complex weight before addition. The complex weight has a real part and an imaginary part.

Furthermore, the artificial neural network may have an output layer having at least one output neuron, to which the results of the multiplication of at least some of the multiplicative units are supplied, which are each multiplied by a complex output weight and are then added in order to provide a complex output signal from the output neuron. The complex output signal has a real part and an imaginary part.

A measure of the confidence or reliability of the complex output signal can be advantageously provided by means of the imaginary part of the complex output signal.

According to one preferred other development of the subject matter of the present disclosure, different subsets of the states are assigned to different modes of the system, each defining a different dynamic behavior of the system, wherein the anomaly is determined in at least two different modes, preferably in all different modes.

In other words, the modes can be used to classify different normal states of the system. Each normal state has state transitions between different states in the respective system mode, wherein in each mode deviations between the predicted future state and the future state captured by means of the at least one capture means are ascertained, from which in turn the anomaly is determined, if necessary.

In this way, different system modes can be assigned, for example, to different operating modes of a machine, wherein the embodiments disclosed herein make it possible to reliably determine anomalies in each machine operating mode.

In a further example, the different system modes when investigating near falls (e.g. stumbling) of living beings can be walking, running and sitting, where a near fall in each of the three system modes is detected as an anomaly of the respective normal state of walking, running or sitting.

According to a further aspect of the present disclosure, a device for detecting an anomaly in the behavior of a dynamic system that has state transitions between a plurality of states comprises at least one capture means and a control unit, wherein the capture means is designed and arranged to capture at least one subset of the states of the system, and the control unit is designed and configured to perform a method as claimed in one of the preceding claims. In particular, the control unit, for example a microcontroller, a microprocessor, a digital signal processor (DSP), a single-board computer and the like, which can have a memory, such as RAM, ROM, flash, etc., is used, inter alia, to perform or control the capture mode and/or detection mode. The capture and detection modes can be performed by different control units, but they can be performed by the same control unit. Due to the low computational effort employed to perform the method according to the present disclosure, the control unit can be designed to be energy-saving and compact, because it only has to be designed for a moderate computing power.

It should be noted that, with regard to method-related definitions of terms and the effects and advantages of method features, recourse may be had in full to the explanations of analogous definitions, effects and advantages of the device according to the disclosed embodiments, and vice versa. In this respect, a repetition of explanations of equivalent features, their effects and advantages with regard to the device according to the embodiments disclosed herein and the method according to the embodiments disclosed herein can be largely dispensed with in favor of a more compact description.

According to one preferred configuration, the at least one capture means is a sensor for capturing a mechanical vibration, an acceleration, a location in space, sound waves, electric, magnetic or electromagnetic fields or any combination thereof.

The device is particularly preferably in the form of an integrated portable unit, e.g. a so-called wearable. In this case, all information may be locally present in the portable unit. An operationally self-sufficient device can be provided by means of an energy storage device (e.g. battery, rechargeable battery) for the electrical supply of the portable unit. The at least one capture means or sensor can be integrated in the device. This provides a portable (e.g. by a living being), mobile and compact device that is inexpensive to produce.

According to a further preferred aspect of the present disclosure, the device disclosed herein is used to detect a near fall of a living being (e.g. a person), wherein the device is worn by the living being and a near fall (e.g. stumbling) while running, walking and/or sitting represents the anomaly of the dynamic system to be detected.

Yet another preferred aspect of the present disclosure provides for the device disclosed herein to be used to monitor a machine, wherein a predetermined deviation from a nominal operating behavior of the machine represents the anomaly to be detected.

The embodiments disclosed herein are used to detect anomalies during the transition of a system from one state to another (herein also referred to as a dynamic system). The system can be, for example, a living being (e.g. human or animal) or an inanimate object such as a machine, a building, a vehicle and the like, wherein the state of the system can be measured by sensors (e.g. portable acceleration sensors for living beings or acoustic, optical, electrical, magnetic, electromagnetic or vibration-responsive sensors and the like that can installed on a building or a machine).

Without mandatory limitation of the disclosed embodiments to this, an important application is the detection of near falls with the aid of portable sensors. This is a very important issue in accident prevention and occupational safety.

For machines, the method is particularly well suited to monitoring based on the observation of the usual sound emissions and the vibration behavior.

In any case, a normal state of the dynamic system can be learnt with the aid of the embodiments disclosed herein with relatively short observation periods. An anomaly in the behavior of the system is characterized by significant deviations from the normal state.

In other words, the disclosed embodiments have the following essential properties:
learning the dynamics of an (unknown) dynamic system (e.g. human, machine, living being) in the form of a model that can be represented as an artificial neural network (preferably as a flat neural network)
predicting (i.e. extrapolating) the expected next state of the system
detecting anomalies as a deviation of the observed state from the expected extrapolated state, e.g. above a tolerance limit (predetermined threshold value)

Preferred areas of application include:
Detection of near falls (prevention and occupational safety)
   sensors worn on the body
   possible online evaluation in real time on a relatively low-performance computer (e.g. smartwatch or wearable)
   continuous analysis of the dynamics and statistical evaluation
   possible training of the neural network on the same device as that used to
   capture the anomalies
Detection of machine damage
   single-board computer or microcontroller possible
   possible direct mounting with integrated sensors
   implementation both on a central computer and on or near machine parts
   detection of machine damage based on anomaly detection
System description for the monitoring/control of technological processes (control loops)
   learning an (unknown) dynamic system of a process from sensor data including monitoring/control parameters
   controlling the process by predicting the future expected state, ascertaining and determining the deviations (anomalies) and initiating appropriate measures
   learning the monitoring/control function as a dynamic system (both reinforcement learning and optimal control methods can be used here)
   implementation on single-board computers or microcontrollers/microprocessors/DSPs possible

The method according to the present disclosure has the task of learning the dynamics (state change from one observation time to the next). The normal state or states can be learnt from these dynamics (i.e. capture mode). This makes it possible to ascertain which of the normal states (in gait analysis, e.g. walking, running, sitting, etc.; in machines, e.g. different working modes) the living being or the inanimate object is in and how large the deviations from the regular state are.

The observed system can be in one of possibly multiple normal states. The dynamics of these states are learnt in the training phase (i.e. in the capture mode). During use (i.e. in the detection mode), the present disclosure then compares the observed state changes with the state changes corresponding to the learnt, predicted and extrapolated normal states. If there is no good correspondence to these predictions, the event will be marked as an anomaly and countermeasures will be taken if necessary.

The dynamics are predicted with the aid of the neural network which, unlike conventional neural networks, can learn multiplicative couplings of the input signals. This can be achieved in particular by using complex-valued weights as well as logarithmic and exponential activation functions in the network.

The already trained network can then be used for anomaly detection. The future state of the dynamic system is thus calculated using the learnt model and compared with the current (measured) state. A direct comparison with the observed dynamic state then allows the anomaly to be detected by calculating the distance. This approach to anomaly detection is only applicable because the neural network of the present disclosure allows the extrapolation of functions.

Significant differences between the method according to the present disclosure and conventional methods are:
Interpretation of the state dynamics as a nonlinear dynamic system driven by relatively simple multiplicative couplings.
Modeling of the dynamic system by way of an interpretable mathematical model which can learn multiplicative couplings independently even with a larger number of input signals.
The learnt model contains relatively few parameters (for example only 7 neurons in a single hidden layer) and can therefore be trained and evaluated very quickly.

These features enable, inter alia:
Training and analysis on low-performance and energy-efficient hardware.
Simultaneous detection of the normal state and possible abnormalities.
Very fine temporal resolution and anomalies may be detected under certain circumstances below a period (for example less than one step), whereas many conventional methods require that at least one period be run through.
The learnt model parameters contain compact information about the system that can be used in further applications (e.g. statistical investigations of gait behavior in different persons or for quality control in production).

### Overview of the Method

### Offline Learning

A recorded data set is used offline to train the model and is usually not executed in real time. However, the learnt exponents and couplings of the model can be stored and used in a real-time variant (see below Online learning). This possibility does not exist in this form in conventional neural networks, since no exponents and couplings can be learnt, but rather it would be necessary to retrain the entire conventional neural network with a large number of parameters.

The method according to the present disclosure also allows the processing of a large number of input signals (e.g. data from acceleration, position, magnetic field sensors, etc.) which can then be multiplicatively coupled to each other in any way. Conventional methods may require the prior determination of these couplings. For example, if there are 10 input channels (i.e. input signals), three of which, for example, are multiplicatively coupled to each other, there are already 10*9*8=720 possible couplings, even if it is assumed that each term reaches at most the first power.

At higher powers, the number of possibilities to be considered, and thus the model size, quickly becomes prohibitively large.

Whereas conventional neural networks consist of different layers that sum the inputs (i.e. input signals) of the previous layer in a weighted manner and then pass the results to the next layer via an activation function, the method according to the present disclosure can use multiplicative units that transfer superimpositions of power laws to the next layer. This is achieved by logarithmizing the inputs or input signals, then passing them to a linear perceptron, for example, and finally exponentiating its output (i.e. output signal). The complex logarithm function and the complex exponential function can also be used to handle negative inputs.

Adapting the network to observations now determines a model that predicts either the n-dimensional state at an instance (e.g., time) p, i.e.

$${\vec{x}}_{p} = ( {x}_{1 , p ,} {x}_{2 , p ,} … , {x}_{n , p} ) \qquad ( 1 )$$

or the state change

$$δ {\vec{x}}_{p} = {\vec{x}}_{p} - {\vec{x}}_{p - 1} \qquad ( 2 )$$

as well as possible from the previous state \vec{x}ₚ₋₁. A state anomaly can be determined when the deviation of the predicted state

$${x}_{p}^{pred}$$

from the actual observed state

$${x}_{p}^{obs}$$

exceeds a certain threshold.

### Online Learning (Real-Time Variant)

In the real-time variant, the multiplicative couplings ascertained offline and their exponents w_{k,j} are specified, with the result that only the weights αₖ have to be determined. This can be achieved directly with much simpler methods, e.g. a linear regression. This is possible, among other things, because the previously determined or learnt exponents wₖⱼ already qualitatively describe the dynamic system by means of the multiplicative couplings (including, if necessary, the different dynamic system modes). The superimpositions of the power functions can be adjusted online with much less effort using the preexponential factors αₖ.

### Anomaly Detection

The already trained neural network can then be used for anomaly detection. The future state of the dynamic system is thus calculated using the learnt model and compared with the current (measured) state. The corresponding mathematical operations are realized by the neural network according to the present disclosure. A direct comparison with the observed dynamic state then allows the anomaly to be detected by calculating the distance. This approach to anomaly detection is only applicable because the neural network of the method according to the present disclosure allows the extrapolation of functions.

### Training of the Network

### Structure of the Network

The network consists of m product units and an output layer, as a result of which the following operations are implemented:
Step 1: The input data consisting of sample vectors of the form x=(x₁, . . . , xₙ) [symbol] ∛{0} are converted into a vector of the form z=(z₁, . . . , zₙ)∈ [symbol] by applying the complex logarithm function and are then transferred as an input to a layer consisting of m product units.
Step 2: Each product unit k contains n complex weights or parameters w_{k,j}. The complex parameters can be represented both in standard form, that is to say w_{k,j}=a_{k,j}+ib_{k,j}, where a_{k,j} and b_{j,k} are real numbers. The input values are multiplied by the corresponding weights and are then added. The complex exponential function is then applied to the weighted sum, thus obtaining

$${y}_{k} = exp [ {\sum }_{j = 1}^{n} ( {ω}_{k , j} {z}_{j} ) ] \qquad ( 3 )$$

$$= {\prod }_{j = 1}^{n} {x}_{j}^{{w}_{k , j}} \qquad ( 4 )$$

as the output value.
Step 3: The output values of the layer of product units are forwarded to an output neuron. This is defined by m complex weights

$${α}_{k} := {α}_{k}^{real} + i {α}_{k}^{imag}$$

and calculates a weighted sum according to

$${o}_{\{ out \}} = {\sum }_{k = 1}^{m} {a}_{k} {y}_{k} \qquad ( 5 )$$

$$= {\sum }_{k = 1}^{m} {a}_{k} exp [ {\sum }_{j = 1}^{n} ( {ω}_{k , j} {z}_{j} ) ] \qquad ( 6 )$$

$$= {\sum }_{k = 1}^{m} {a}_{k} {\prod }_{j = 1}^{n} {x}_{j}^{{w}_{k , j}} \qquad ( 7 )$$

### Learning Rule for Training the Network

For a given data set x={x₁ . . . , x_{N}}, that is to say a set of N sample vectors and a set of observations Y={ô_{1.} . . . , ô_{N}} associated therewith, the aim of training the network is to adjust the parameters of the network such that oₒᵤₜ (xₗ) assumes as accurately as possible the value

$${\hat{o}}_{l}^{soll}$$

for l=1, . . . , N or minimizes the value of an appropriately selected cost function L(X,Y).

In this case, it should be taken into account that the network can provide complex-valued output values. Specifically, the network is adjusted to the data set using the cost function

$$L ( X , Y ) = \frac{1}{N} {\sum }_{l = 1}^{N} {\vert {o}_{out} ( {x}_{l} ) - {\hat{o}}_{l} \vert}^{2} \qquad ( 8 )$$

where |⋅| represents the absolute value of a complex number, that is to say |z|²=zz̅. If u:=real(oₒᵤₜ) and v==imag(oₒᵤₜ) are defined as real and imaginary parts of the output oₒᵤₜ and û and \hat{v} are defined as real and imaginary parts of ô, the following are obtained

$$L ( X , Y ) = \frac{1}{N} {\sum }_{l = 1}^{N} {( u ( {x}_{l} ) - {u}_{l} )}^{2} + \frac{1}{N} {\sum }_{l = 1}^{N} {( v ( {x}_{l} ) - {\hat{v}}_{l} )}^{2} \qquad ( 9 )$$

$$\text{=:} {L}_{real} ( X , Y ) + {L}_{imag} ( X , Y ) \qquad ( 10 )$$

This approach has the advantage that imaginary parts of the output can also be punished during optimization.

Minimizing the cost function using the gradient descent method for each individual sample leads to the gradients

$$Δ {α}_{k}^{real} = \frac{\partial L ( X , Y )}{\partial {α}_{k}^{real}} \qquad ( 11 )$$

$$Δ {α}_{k}^{imag} = \frac{\partial L ( X , Y )}{\partial {α}_{k}^{imag}} \qquad ( 12 )$$

$$Δ {α}_{k , j}^{} = \frac{\partial L ( X , Y )}{\partial {α}_{k , j}^{}} \qquad ( 13 )$$

$$Δ {b}_{k , j}^{} = \frac{\partial L ( X , Y )}{\partial {b}_{k , j}^{}} \qquad ( 14 )$$

and learning rules with the learning rate λ

$${α}_{k}^{real} ← {α}_{k}^{real} - λ Δ {α}_{k}^{real} \qquad ( 15 )$$

$${α}_{k}^{imag} ← {α}_{k}^{imag} - λ Δ {α}_{k}^{imag} \qquad ( 16 )$$

$${α}_{k , j}^{} ← {α}_{k , j}^{} - λ Δ {α}_{k , j}^{} \qquad ( 17 )$$

$${b}_{k , j}^{} ← {b}_{k , j}^{} - λ Δ {b}_{k , j}^{} \qquad ( 18 )$$

An analytical calculation of the gradients leads to

$$Δ {α}_{k}^{real} = 2 ( u - \hat{u} ) {u}_{k} + 2 ( v - \hat{v} ) {v}_{k} \qquad ( 19 )$$

$$Δ {α}_{k}^{imag} = - 2 ( u - \hat{u} ) {v}_{k} + 2 ( v - \hat{v} ) {u}_{k} \qquad ( 20 )$$

$$Δ {α}_{k , j}^{} = 2 ( u - \hat{u} ) ( - {b}_{k , j} {v}_{k} + {α}_{k , j} {u}_{k} ) + 2 ( v - \hat{v} ) ( {u}_{k} {b}_{kj} + {v}_{k} {a}_{kj} ) \qquad ( 21 )$$

$$Δ {b}_{k , j}^{} = 2 ( u - \hat{u} ) ( - {a}_{k , j} {v}_{k} + {b}_{k , j} {u}_{k} ) + 2 ( v - \hat{v} ) ( - {u}_{k} {b}_{kj} + {u}_{k} {a}_{kj} ) \qquad ( 22 )$$

It should be understood that the above mathematical description is merely an example and serves the purpose of further clarifying the principles underlying the disclosed embodiments. The present disclosure is by no means exclusively limited to this.

The derivatives for the gradient descent can also be formed by automatic or symbolic differentiation.

Instead of the gradient descent, other optimization methods that are known per se are also possible, as are heuristics such as simulated annealing.

The following variants of the method are conceivable:
1. Representation of the weights in polar form, that is to say ω_{k,j}=r_{k,j}e^{iφk,j} with real r_{k,j} and φ_{k,j}, and training of the amplitude and phase instead of real and imaginary parts of the weights.
2. Preprocessing layer for the purpose of linear transformation of the data
3. Postprocessing layer
4. Alternative cost functions: for example amplitude of the complex output, regularization terms
5. The output layer can be expanded in order to generate a plurality of outputs, for example for describing functions ∈ [symbol] .
6. Samples from a past time window or only a subset of these samples can be used to train the model and predict the current state. This allows the dimensionality of the problem to be reduced without excluding information that is further back in time.
7. Both the logarithmized input data and non-logarithmized input data can be forwarded to the product units (see step 2 above). This allows complex-valued exponential functions (including sine and cosine functions) to be introduced as multiplicative and/or additive terms. It is thus also possible to describe non-linear differential equations with periodic terms, e.g. a periodically driven oscillator. The function ƒ(x)=x cos (3×) can be used as an example.

The output signals from the method according to the present disclosure can be complex-valued, which has the direct advantage that the imaginary parts can be penalized in the optimization via a corresponding cost function (see equation 8). This has a positive effect on the convergence of the method.

### Possible Preferred Upper and Lower Limits for the Number of Neurons

Based on the training and validation error, the number of multiplicative units utilized can be ascertained. If further addition of multiplicative units does not reduce the training and validation error, this process must be stopped. Since the method according to the present disclosure uses only small networks (i.e. number of neurons preferably less than or equal to 30), this method can be carried out. This method is suitable for the offline mode. In the online mode, the basis is then network sizes that have proven themselves in the offline mode.

### BRIEF DESCRIPTION OF THE DRAWINGS

Further features and advantages of the disclosed embodiments emerge from the following description of an example embodiment of the various disclosed embodiments which should not be construed as limiting and is explained in more detail below with reference to the drawing. In this drawing:

FIG. 1 schematically shows an application example of anomaly detection according to an exemplary embodiment of a method according to an embodiment,

FIG. 2 schematically shows a first example of a capture mode for the application shown in FIG. 1 according to the exemplary embodiment of the method according to an embodiment,

FIG. 3 schematically shows a second example of a capture mode for the application shown in FIG. 1 according to the exemplary embodiment of the method according to an embodiment,

FIG. 4 schematically shows an example of a prediction of a system state in a detection mode according to the exemplary embodiment of the method according to an embodiment,

FIG. 5 schematically shows a modeling result of an exemplary function ƒ (x)=x cos (3×), and

FIG. 6 schematically shows a comparison of a real system and a simulated dynamic system.

In the different figures, parts of equivalent function are always provided with the same reference signs, and so they are also usually described only once.

### DETAILED DESCRIPTION

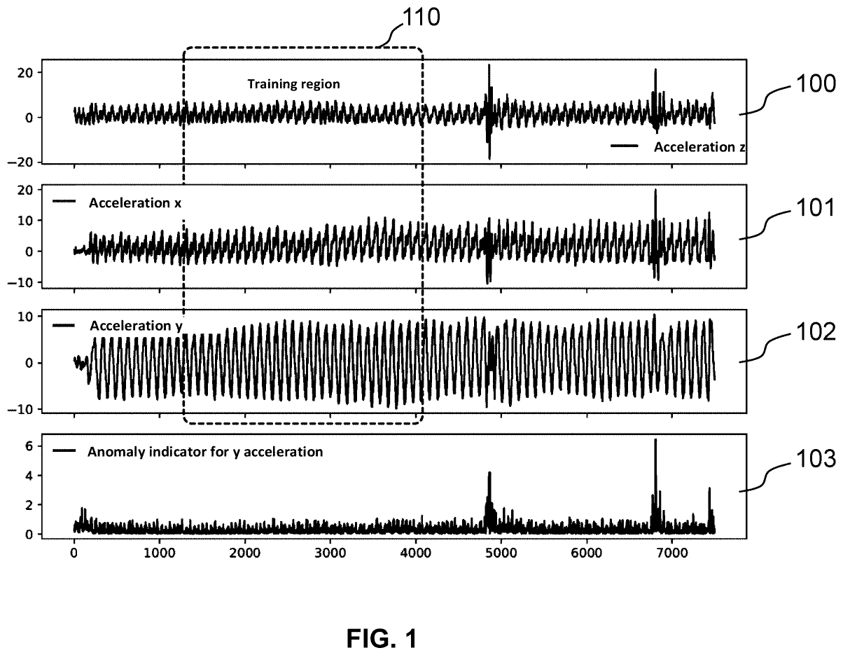

FIG. 1 illustrates, by way of example, results for anomaly detection. The upper three rows 100, 101, 102 illustrate the x, y and z accelerations which were measured by a capture means (acceleration sensors in the present case) and were recorded during walking with a smartphone. Three stumbling events can be seen. Offline training of the model over the training region 110 with a dashed border allows the prediction of the acceleration in the y direction with the current measurement over the squared distance (see bottom row 103).

Undisturbed walking (i.e. normal state) corresponds to an almost periodic signal with a slightly varying amplitude. The two near fall events are quite recognizable by peaks in the z and x components. These disturbances in the y component are much less noticeable.

As an anomaly indicator 103, an ascertained time series of the deviation of the expected acceleration from the observed acceleration in the y direction is determined using the exemplary method (anomaly indicator function). Although the acceleration data in this direction have no clear peaks, the method according to an embodiment can clearly identify the anomalies (shortly before 5000 and 7000 [1/100 sec]).

The stumbling events are clearly recognizable and can now be detected by applying a threshold value and can be assigned to an exact time.

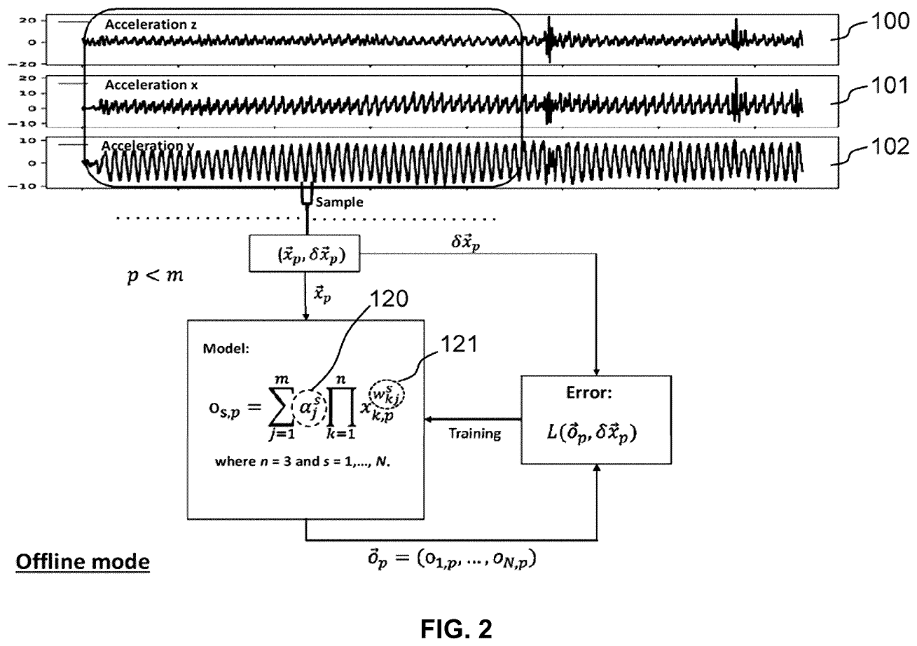

FIG. 2 illustrates, by way of example, offline learning of the model or neural network according to an example embodiment of. The weights 120, 121 are adjusted based on sample data. Here, samples collected over a comparatively longer period of time can be processed in order to determine the exponents wₖⱼ and thus the multiplicative couplings present in a system as precisely as possible.

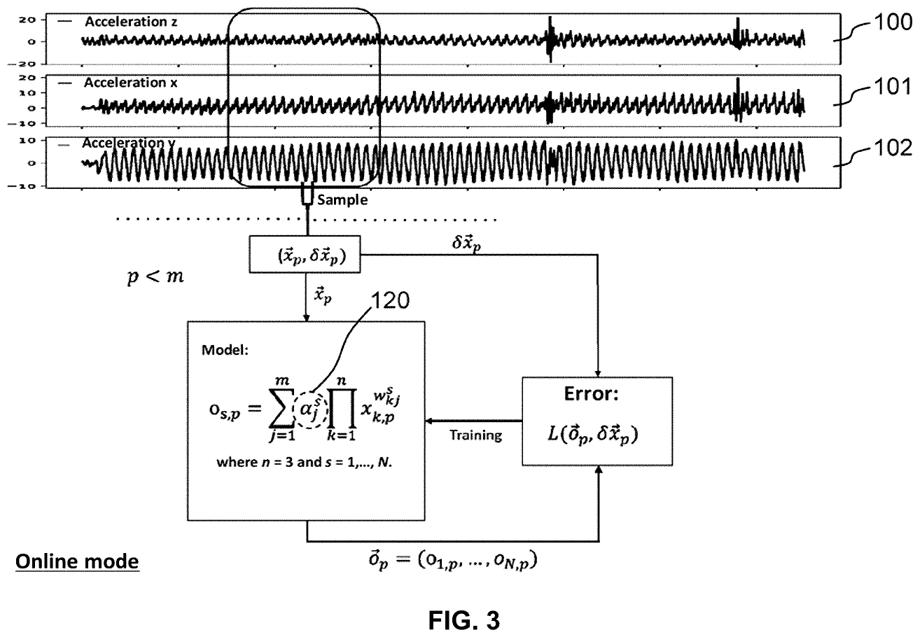

FIG. 3 illustrates, by way of example, online learning of the model or neural network according to an example embodiment. The multiplicative couplings learnt in the offline learning, given by the weights wₖⱼ, are frozen during online learning. In the online mode, only the weights αⱼ are adjusted to the current sample using linear regression. This is possible, among other things, because the previously determined or learnt exponents wₖⱼ qualitatively describe the dynamic system by means of the multiplicative couplings (including, if necessary, the different dynamic system modes). The superimpositions of the power functions can be adjusted online with much less effort using the preexponential factors αₖ.

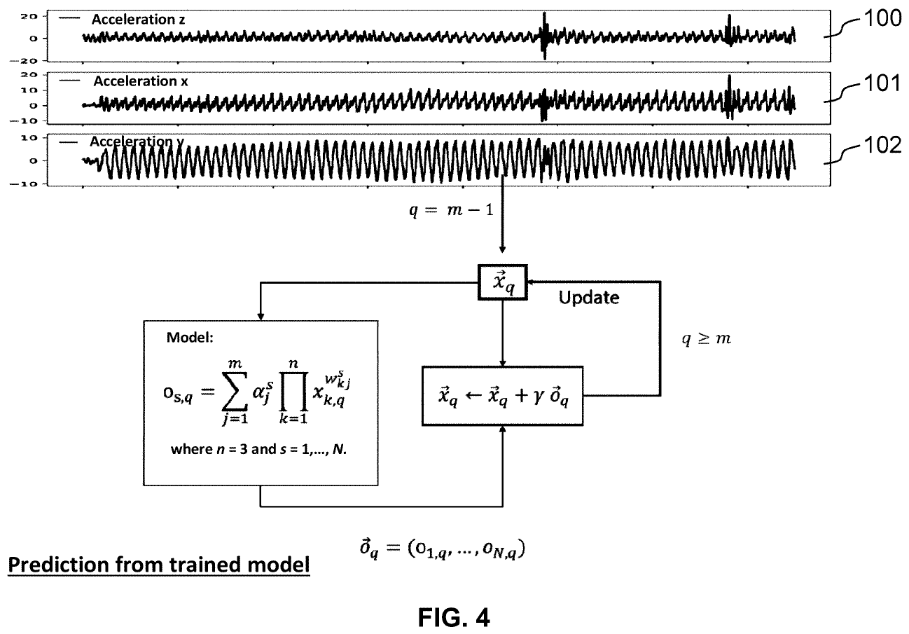

FIG. 4 illustrates the use of the models or neural networks learnt in the offline and online modes according to an example embodiment in order to predict the development of the dynamic system.

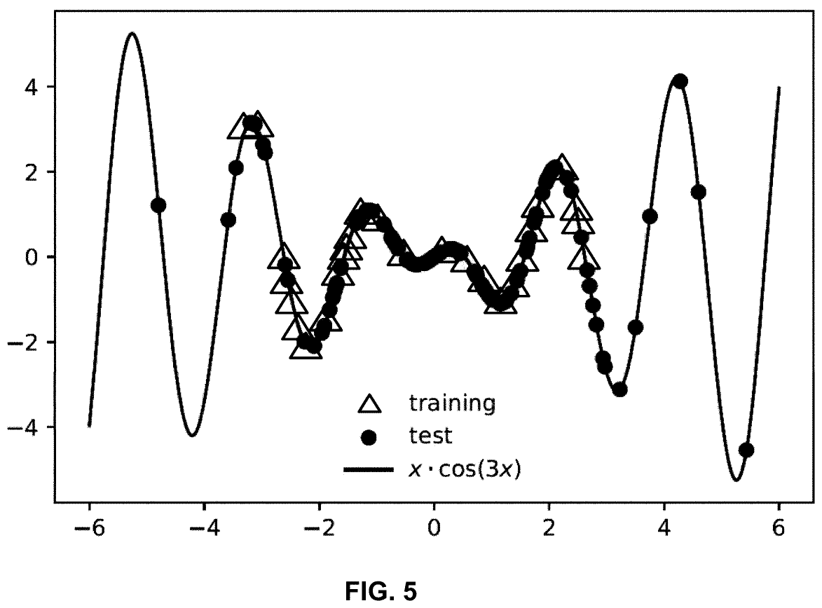

FIG. 5 illustrates successful modeling of the function ƒ(x)=x cos (3×) according to variant 7 described above. The function is represented in FIG. 5 as a solid line, the training data are represented by means of triangles and the results of a test are represented by means of circular disks. It can be clearly seen that the function has been successfully learnt and the test results substantially have a deviation from the actual course of the function ƒ(x)=x cos (3×). In addition, the test result in FIG. 5 also clearly shows that the disclosed embodiments precisely enables the function to be extrapolated beyond the range of the provided training data (see test points for x<−3 and x>3)).

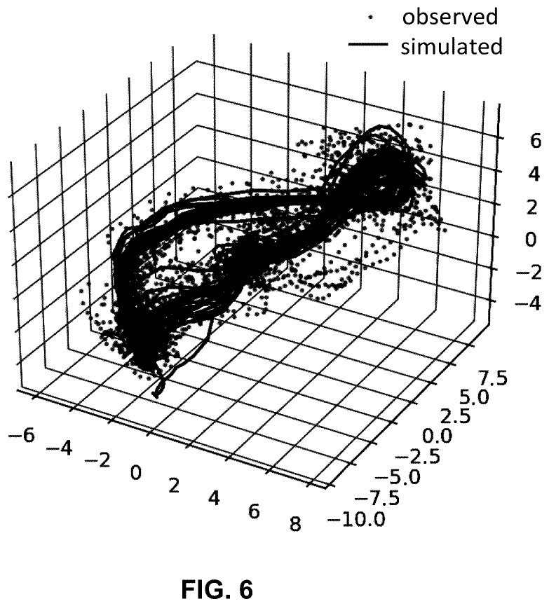

FIG. 6 illustrates a comparison of an exemplary real, observed dynamic system and its corresponding simulation by means of a learnt model according to an embodiment. A good correspondence can be seen between the real system and its predicted behavior based on the disclosed embodiments.

For training a model of the dynamic system, i.e. for training the artificial neural network, a device (e.g. a wearable, a smartphone or the like) for detecting an anomaly in the behavior of the dynamic system—or alternatively a further device separate from it—can provide a user interface that allows a user to train the model interactively and apply it to test data in order to check the quality of the learnt model. For this purpose, the user preferably selects a training region (e.g. from streamed data from the capture means) which is used to train the dynamic system (cf. FIGS. 1-3). The user interface allows various parameters of the method to be set, e.g. the number of product units, the learning rate, an index selection of the samples to be used for training (see variant 6). The interface allows a data stream of captured states of the system to be received, e.g. to be retrieved from a wearable, allows measurements to be started online and to be carried out, and allows the learnt models to be stored. The predictions of the learnt model can be displayed on a display of the device. The anomaly indicator function (cf. FIG. 1) can be calculated and can also be displayed on the display. The learnt models can be applied to new data from a detection mode and used to classify movement states.

The device according to embodiments disclosed herein as well as the method according to disclosed embodiments for detecting an anomaly in the behavior of a dynamic system are not limited to the specific embodiments disclosed herein in each case, but also each comprise identically acting further embodiments which result from technically useful further combinations of the features described herein, both of the device and of the method. In particular, the features and combinations of features mentioned hereinabove in the general description and the description of the figures and/or shown in the figures alone can be used not only in the respective combinations explicitly specified herein, but also in other combinations or alone, without departing from the scope of the present disclosure.

The device disclosed herein for detecting an anomaly in the behavior of a dynamic system is particularly advantageously used for near fall detection (e.g. stumbling) of a living being (e.g. a human), wherein the device is worn by the living being and a near fall during running, walking and/or sitting represents the anomaly to be detected.

The device disclosed herein for detecting an anomaly in the behavior of a dynamic system is advantageously used according to a further configuration to monitor a machine, wherein a predetermined deviation from a nominal operating behavior of the machine represents the anomaly to be detected. The machine can have different operating modes, and the anomaly can be determined for each operating mode.

The present disclosure is not necessarily limited exclusively to the above-described applications. It can also be advantageously used in other cases in which the behavior of a dynamic system is intended to be observed, in which anomalies or significant deviations can occur compared to a normal, nominal dynamic behavior of the system, on the basis of which appropriate countermeasures can be initiated at an early stage, in particular in order to prevent or at least mitigate (further) damage to the dynamic system. An example would be a robot arm that is disturbed in the planned movement.

By contrast, if there are no anomalies, the system can also be used to provide positive feedback and signal that the movements have been performed correctly. In this way, it can be used, for example, for training purposes in sports or for learning movements in rehabilitation. The sensor can also be installed in sports equipment. The feedback signal can also gradually signal a deviation from the desired movement, e.g. through acoustic signals, for example in order to learn a desired movement sequence.

What is claimed is:

1. A method for detecting an anomaly in the behavior of a dynamic system that has state transitions between a plurality of states, comprising:
capturing at least one subset of the plurality of states in a capture mode, wherein the at least one subset of the plurality of states is used to train an artificial neural network;
predicting, in a detection mode, a future state of the dynamic system by the artificial neural network;
capturing the future state of the dynamic system using a capture sensor, ascertaining a deviation of the captured future state from the predicted future state; and
determining the anomaly from the ascertained deviation.

2. The method as claimed in claim 1, wherein the anomaly is determined by a predetermined threshold value being exceeded by the ascertained deviation.

3. The method as claimed in claim 1, wherein the artificial neural network has at least one hidden layer with hidden neurons.

4. The method as claimed in claim 3, wherein the hidden neurons are each in a form of multiplicative units which are each supplied with input signals that are multiplied by each other by the respective multiplicative unit.

5. The method as claimed in claim 4, further comprising:
logarithmizing the input signals in order to perform the multiplication;
adding the logarithmized input signals; and
exponentiating the result of the addition.

6. The method as claimed in claim 5, wherein the input signals are logarithmized using a complex logarithm function and the result of the addition is exponentiated using a complex exponential function.

7. The method as claimed in claim 5, wherein the logarithmized input signals are each multiplied by a complex weight before addition.

8. The method as claimed in claim 4, wherein the artificial neural network has an output layer having at least one output neuron, to which the results of the multiplication of at least some of the multiplicative units are supplied, which are each multiplied by a complex output weight and are then added in order to provide a complex output signal from the output neuron.

9. The method as claimed in claim 8, wherein a measure of the confidence of the complex output signal is provided by means of an imaginary part of the complex output signal.

10. The method as claimed in claim 1, wherein different subsets of the plurality of states are assigned to different modes of the dynamic system, each of the different subsets defining a different dynamic behavior of the dynamic system, wherein the anomaly is determined in at least two different modes.

11. The method as claimed in claim 3, wherein the artificial neural network has a maximum of 50 neurons in the hidden layer.

12. A device for detecting an anomaly in the behavior of a dynamic system that has state transitions between a plurality of states, comprising:
at least one capture sensor; and
a control unit, wherein the capture sensor is designed and arranged to capture at least one subset of the states, and wherein the control unit is designed and configured to:
capture at least one subset of the plurality of states in a capture mode, wherein the at least one subset of the plurality of states is used to train an artificial neural network;
predict, in a detection mode, a future state of the dynamic system by the artificial neural network;
capture the future state of the dynamic system using a capture sensor,
ascertain a deviation of the captured future state from the predicted future state; and
determine the anomaly from the ascertained deviation.

13. The device as claimed in claim 12, wherein the at least one capture sensor is a sensor for capturing at least one of: a mechanical vibration, an acceleration, a location in space, sound waves, electric fields, magnetic fields, and electromagnetic fields.

14. The device as claimed in claim 12, wherein the device is in a form of an integrated portable unit.

15. The device as claimed in claim 12, wherein the device is used for near fall detection of a living being, wherein the device is carried by the living being and a near fall during running, walking and/or sitting represents the anomaly to be detected.

16. The device as claimed in claim 12, wherein the device is used to monitor a machine, wherein a predetermined deviation from a nominal operating behavior of the machine represents the anomaly to be detected.

17. The method as claimed in claim 1, wherein the artificial neural network has only one hidden layer with hidden neurons.
